(19) United States
(12) Patent Application Publication
(10) Pub. No.: US 2016/0298427 A1
(43) Pub. Date: Oct. 13, 2016

(54) CONTINUUM SEDIMENTARY BASIN MODELING USING PARTICLE DYNAMICS SIMULATIONS

(71) Applicant: Schlumberger Technology Corporation, Sugar Land, TX (US)

(72) Inventors: Armin I. Kauerauf, Aachen (DE); Adrian Kleine, Aachen (DE); Michael Fuecker, Herzogenrath-Kohlscheid (DE); Thomas Fuchs, Herzogenrath-Kohlscheid (DE)

(21) Appl. No.: 14/682,213

(22) Filed: Apr. 9, 2015

(51) Int. Cl. E21B 43/00; G06F 17/11; E21B 47/00

(52) U.S. Cl. CPC E21B 43/00; E21B 47/00; G06F 17/11

(57) ABSTRACT

A method for performing a field operation within a geologic basin includes obtaining two basin snapshots of the geologic basin, performing a particle dynamics simulation of the geologic basin using at least the two basin snapshots to generate an intermediate basin snapshot, performing, using at least the intermediate basin snapshot as a constraining condition, a basin simulation of the geologic basin to generate a simulated evolution of the basin rock geometry within the geologic basin, and performing, based on the simulated evolution of the basin rock geometry, the field operation within the geologic basin.

### BACKGROUND

Exploration and production (E&P) of hydrocarbons in a field, such as an oil field, may be analyzed and modeled. The analysis and modeling may include sedimentary basin simulation, subsurface hydrocarbon reservoir charge modeling, geological modeling, subsurface rock formation petrophysical properties evaluation, and downhole fluid analysis. Based on the result of the analysis and modeling, hydrocarbons may be extracted from the field. Thus, accurate models are useful for the extraction of hydrocarbons.

### SUMMARY

In general, in one aspect, improving continuum sedimentary basin models with particle dynamics simulations relates to a method for performing a field operation within a geologic basin having rock formations. The method includes obtaining a first basin snapshot of the geologic basin. The first basin snapshot includes a basin rock geometry estimate for a first geologic time, the basin rock geometry estimate estimating a basin rock geometry for the plurality of rock formations. The method may further include obtaining a second basin snapshot of the geologic basin, where the second basin snapshot includes the basin rock geometry estimate for a second geologic time. The method may further include performing a particle dynamics simulation of the geologic basin using at least the first basin snapshot and the second basin snapshot to generate an intermediate basin snapshot. The intermediate basin snapshot includes the basin rock geometry estimate for an intermediate geologic time. The intermediate geologic time is after the first geologic time and before the second geologic time. The method may further include performing, using at least the intermediate basin snapshot as a constraining condition, a basin simulation of the geologic basin to generate a simulated evolution of the basin rock geometry within the geologic basin, and performing, based on the simulated evolution of the basin rock geometry, the field operation within the geologic basin.

Other aspects will be apparent from the following description and the appended claims.

### BRIEF DESCRIPTION OF DRAWINGS

The appended drawings illustrate several embodiments of improving continuum sedimentary basin models with particle dynamics simulations and are not to be considered limiting of its scope, for improving continuum sedimentary basin models with particle dynamics simulations may admit to other equally effective embodiments.

FIG. 1.1 is a schematic view, partially in cross-section, of a field in which one or more embodiments of improving continuum sedimentary basin models with particle dynamics simulations may be implemented.

FIG. 1.2 shows a schematic diagram of a system in accordance with one or more embodiments.

FIG. 2 shows a flowchart in accordance with one or more embodiments.

FIGS. 3.1, 3.2, 3.3, and 3.4 show an example in accordance with one or more embodiments.

FIG. 4 shows a computing system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that one or more embodiments may be practiced without these specific details. In other instances, well-known features have not been described in detail to avoid unnecessarily complicating the description.

In general, embodiments provide a method and system for performing a field operation within a geologic basin having multiple rock formations. In particular, basin snapshots of the geologic basin are obtained where each basin snapshot includes a basin rock geometry estimate for a particular geologic time. Using two consecutive basin snapshots, a particle dynamics simulation of the geologic basin is performed to generate one or more intermediate basin snapshot corresponding to one or more intermediate geologic time. Using at least one intermediate basin snapshot as a constraining condition, a basin simulation of the geologic basin is performed to generate a simulated evolution of the basin rock geometry within the geologic basin. Accordingly, the field operation is performed within the geologic basin based on the simulated evolution of the basin rock geometry.

In one or more embodiments, the geologic basin further includes a reservoir containing fluids, such as hydrocarbons. In such embodiments, performing the basin simulation further generates the simulated evolution of a fluids distribution within the geologic basin, and performing the field operation is further based on the simulated evolution of the fluids distribution.

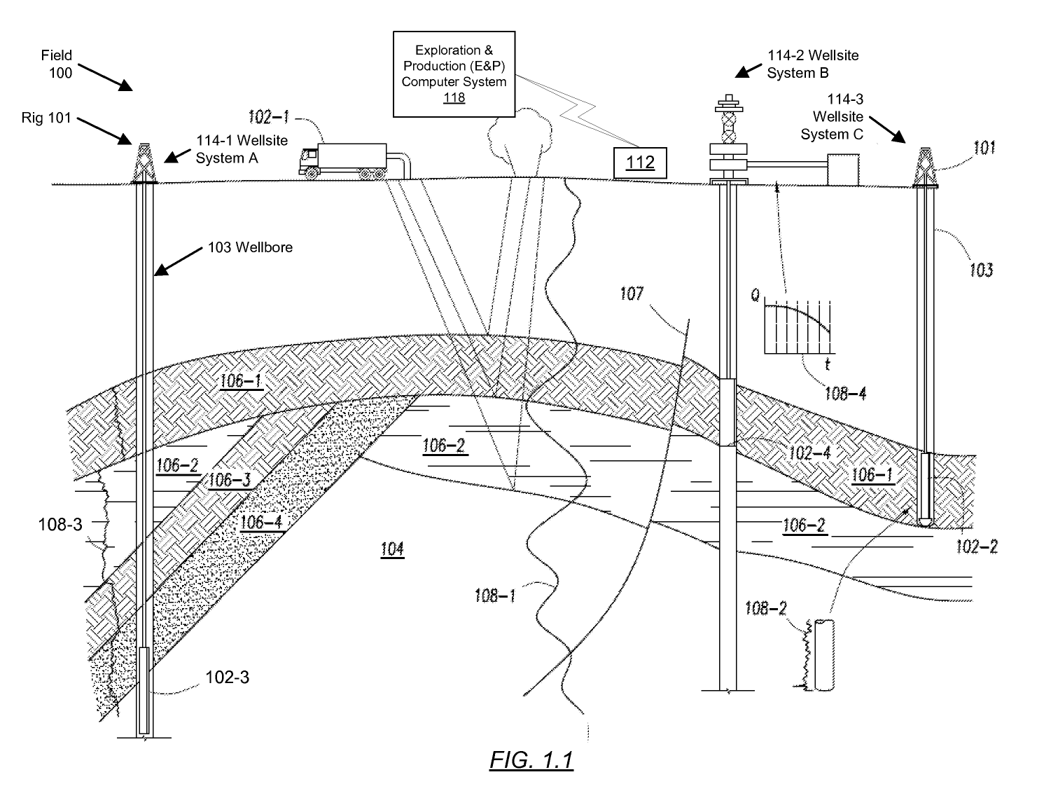

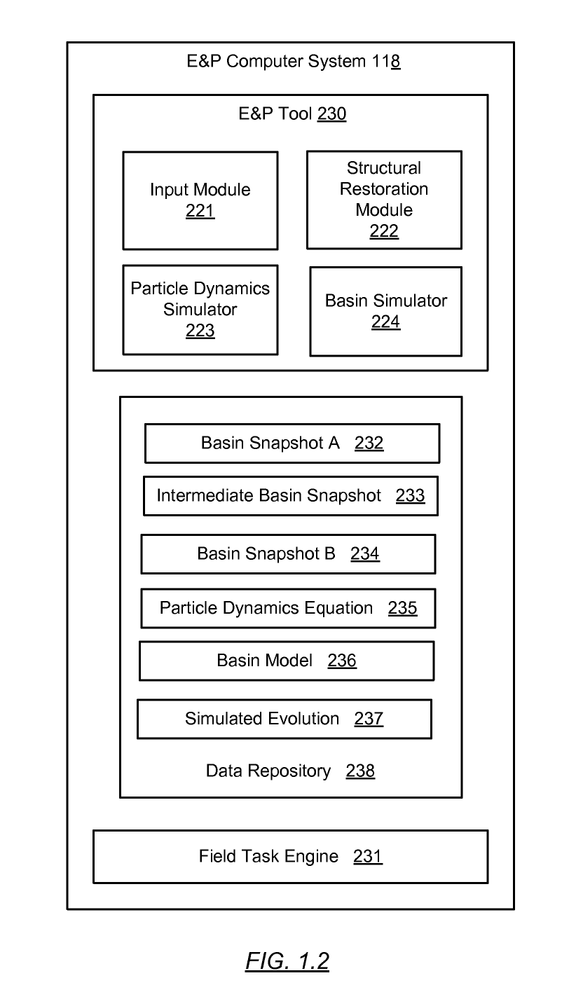

FIG. 1.1 depicts a schematic view, partially in cross section, of a field (100) in which one or more embodiments of improving continuum sedimentary basin models with particle dynamics simulations may be implemented. In one or more embodiments, one or more of the modules and elements shown in FIG. 1.1 may be omitted, repeated, and/or substituted. Accordingly, embodiments of improving continuum sedimentary basin models with particle dynamics simulations should not be considered limited to the specific arrangements of modules shown in FIG. 1.1.

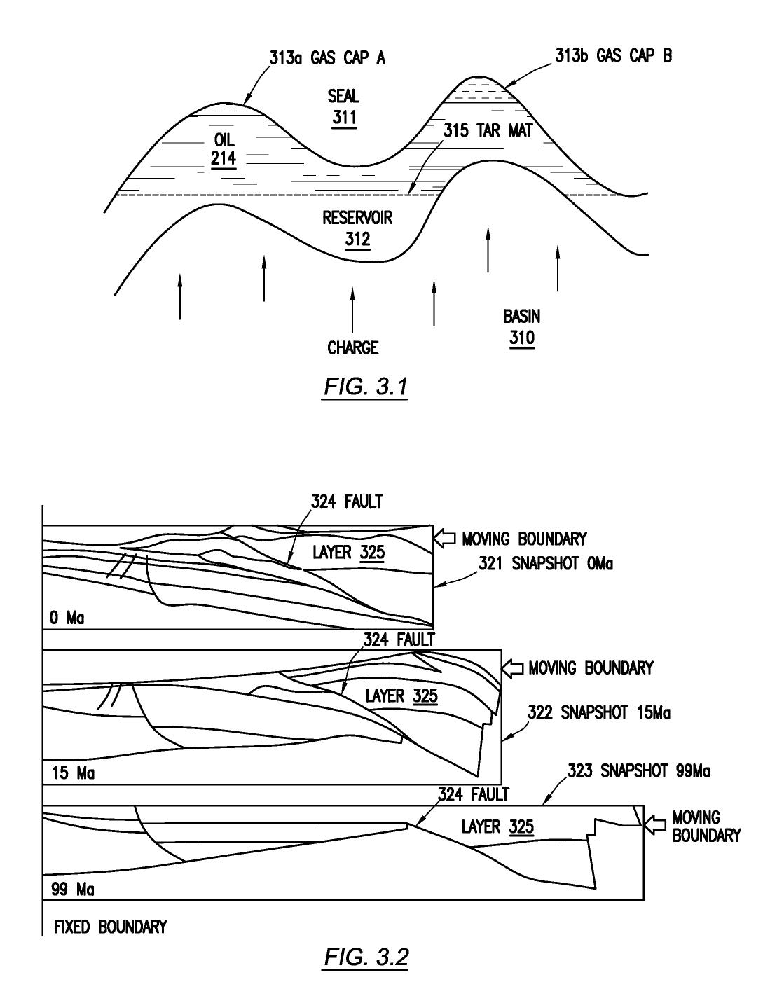

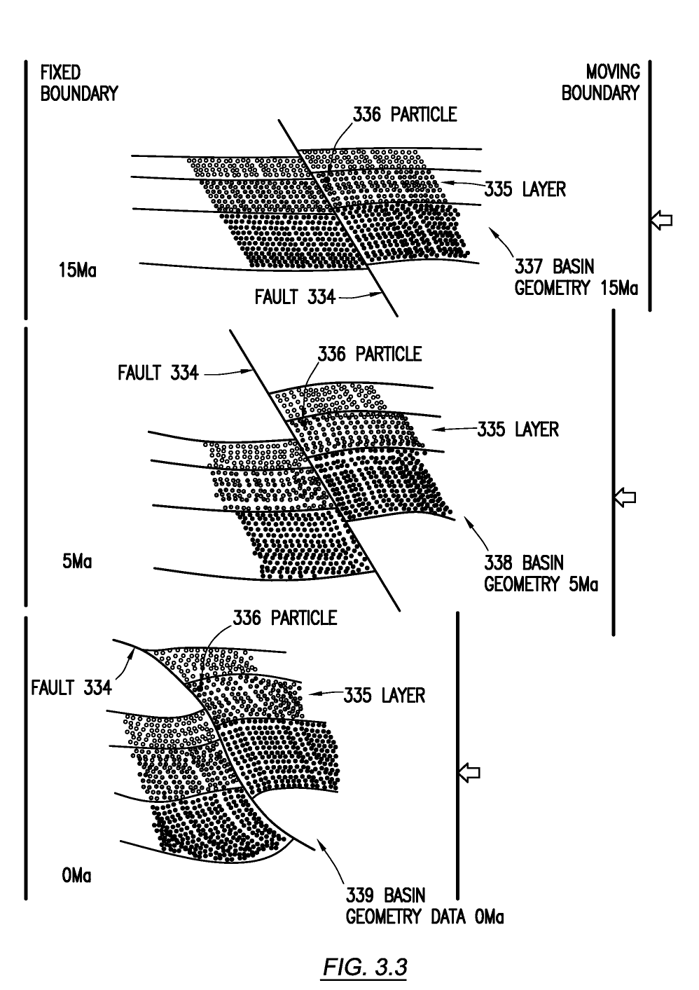

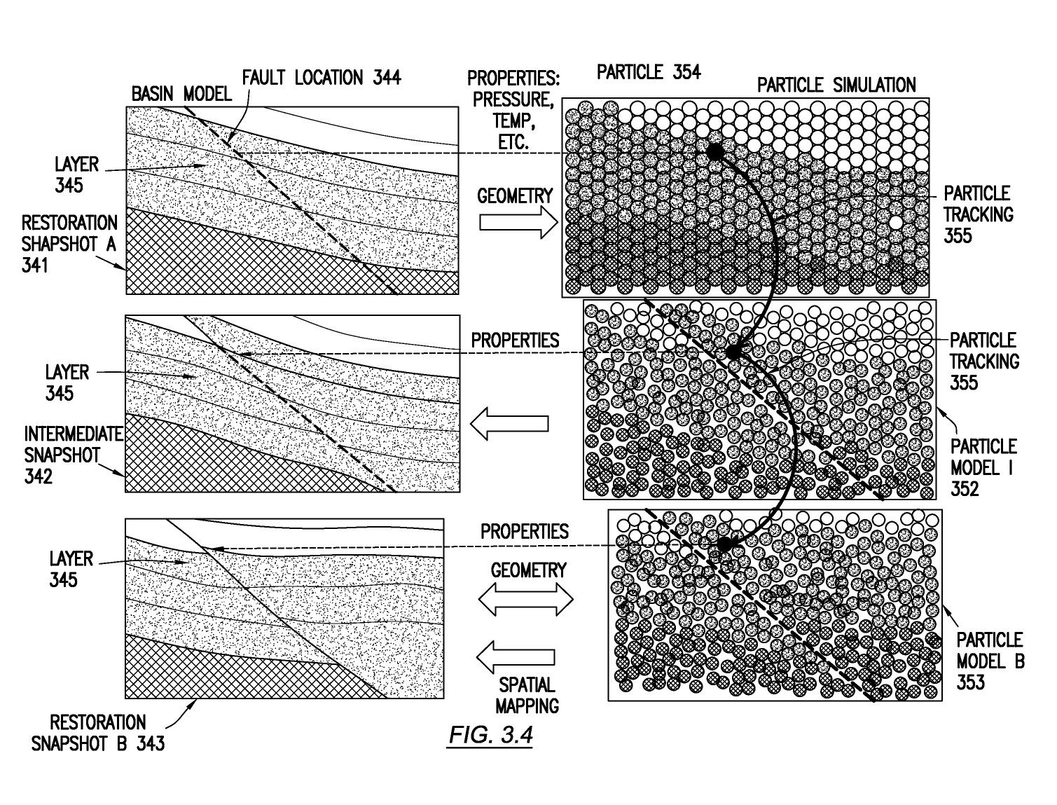

As shown in FIG. 1.1, the field (100) includes the subterranean formation (104), data acquisition tools (102-1), (102-2), (102-3), and (102-4), wellsite system A (114-1), wellsite system B (114-2), wellsite system C (114-3), a surface unit (112), and an exploration and production (E&P) computer system (118). The subterranean formation (104) includes several geological structures, such as a sandstone layer (106-1), a limestone layer (106-2), a shale layer (106-3), a sand layer (106-4), and a fault line (107). A portion of the subterranean formation (104) may be a geologic basin, such as a sedimentary basin. In particular, the geologic basin includes rock formations and at least one reservoir containing fluids. In one or more embodiments, the rock formations include at least one source rock and the shale layer (106-3) includes an active kerogen. An example of the geologic basin is described in reference to FIG. 3.1 below.

By way of further discussion of the geologic basin and basin modeling techniques, geologic sedimentary basin is a depression in the surface of the Earth's crust that undergoes infilling with sediment deposits. Such sediments are derived from weathered rock formations, from biogenic activity, from precipitation of minerals from solution and combinations of the foregoing. When deposited sediments are buried, the sediments are subjected to increasing pressure and temperature. Such burial and subjecting to elevated pressure and temperature begin the process of lithification, which is conversion of unconsolidated sediments into rock formations.

Petroleum (i.e., oil and gas) may be formed within a basin by chemical reactions of sedimentary biogenic precursor material. After generation, petroleum is spatially distributed within the basin via permeable pathways until the petroleum accumulates within porous and permeable reservoir rock formations, or the petroleum is dissipated by chemical or biochemical reactions, or leakage to the surface of the basin. Within any particular basin, one or more “plays” for possible production of hydrocarbons may exist. The United States Geological Survey defines a “play” as “a set of discovered or undiscovered oil and gas accumulations or prospects that exhibit nearly identical geological characteristics such as trapping style, type of reservoir and nature of the seal”. A reservoir may include several different plays which differ from each other by the nature of the fluids within the pore spaces of the rock formations and/or the pressure thereof. A “reservoir” is a rock formation with substantially uniform rock mineral properties and spatial distribution of permeability such that the rock formation has the capability to store fluids, and has the capability for fluids to be moved therethrough by application of suitable pressure variations.

Basin modeling (or basin simulation) is a technique for modeling geological processes that may have occurred in sedimentary basins over geological times. For example, basin modeling may simulate the deposition and erosion of sediments through geologic time, calculating the temperature, pressure and rock stress distribution. Input parameters to the basin modeling include burial history, paleo-water-depth maps, SWITs (sediment water interface temperatures), HF maps, and several rock attributes (e.g., thermal conductivities, permeabilities, rock densities, radiogenic sources). During the basin modeling, temperatures and pressures are determined by solving a differential equation e.g., by using a finite element solver. In one or more embodiments, basin modeling may be used without considering any hydrocarbon fluids or reservoir. In one or more embodiments, overpressure prediction may be performed with basin modeling to reveal basin-wide water flow connectivities, porosity distributions correlating with potential hydrocarbon storage capacity and fracturing, i.e., sealing strengths of potential hydrocarbon storage containers. Further, basin modeling may also be used for evaluation of basin-wide temperature distributions, which is the main controlling parameter determining the velocity of chemical reactions for generation of hydrocarbons within source rocks. Accordingly, the maturity defining the hydrocarbon bearing potential of source rocks may be modeled.

In one or more embodiments, the basin modeling includes petroleum system modeling that simulates the events leading to generation, migration and accumulation of hydrocarbons in reservoir rocks. In such embodiments, inputs to basin modeling include the “charge potential” (e.g., source rock fractional hydrocarbon precursor content, source rock thickness, and hydrocarbon properties), and the trap (e.g., the reservoir geometry, reservoir and seal qualities) of a play. In one or more embodiments, the basin modeling may also include modeling the thermal, pressure and hydrocarbon generation and migration history to make predictions of current hydrocarbon quality and spatial distribution within the basin. In one or more embodiments, the basin modeling may also include a description of petroleum fluids (e.g., pressure, volume, and temperature (PVT), composition, etc.) that is determined, at least in part, by the processes of generation and expulsion that govern the overall composition of the fluids, and the PVT behavior responsible for the distribution of components in each fluid phase during secondary migration and accumulation in a reservoir. The charge history of an accumulation or an individual reservoir may be tracked in compositional form according to selected compound classes, for example, CO₂, H₂S, methane, C₂₋₅, C₆₋₁₅, C₁₆₊. Thermodynamic models known as equations of state, e.g., SRK (Soave-Redlich-Kwong) and PR (Peng-Robinson), may be used to make phase property predictions such as gas-oil ratio (GOR), fluid density and/or fluid viscosity. Post-accumulation alteration processes such as biodegradation, water washing, and oil-to-gas cracking may also be simulated. Source rock tracking, the evolution of the composition through time, yields and compositions of the products generated and released may also be modeled.

The spatial and temporal extent covered by basin models is larger than for reservoir simulation models. Basin models may cover substantial parts of sedimentary basins, often from about 100 kilometer (km) in lateral extension and 10 km in depth up to 1000 km in lateral size. The temporal extension covers all relevant geological events usually going back in geological time more than 100 million years. Reservoir models generally cover lateral sizes a few km or less and are restricted to selected reservoir formations in depth, such as hundreds of meters. Reservoir simulation timescales refer to petroleum production timescales and may range from days to decades. Therefore, the spatial and temporal resolution of basin models is lower than that required for reservoir simulation. Some post-migration processes that affect the quality of the hydrocarbon, such as biodegradation and water washing known to occur on timescales beyond reservoir simulation capabilities, may be better modeled at the basin scale.

Returning to the discussion of FIG. 1.1, in one or more embodiments, data acquisition tools (102-1), (102-2), (102-3), and (102-4) are positioned at various locations along the field (100) for collecting data of the subterranean formation (104), referred to as survey operations. In particular, the data acquisition tools are adapted to measure the subterranean formation (104) and detect the characteristics of the geological structures of the subterranean formation (104). For example, data plots (108-1), (108-2), (108-3), and (108-4) are depicted along the field (100) to demonstrate the data generated by the data acquisition tools. Specifically, the static data plot (108-1) is a seismic two-way response time. Static plot (108-2) is core sample data measured from a core sample of the formation (104). Static data plot (108-3) is a logging trace, referred to as a well log. Production decline curve or graph (108-4) is a dynamic data plot of the fluid flow rate over time. Other data may also be collected, such as historical data, analyst user inputs, economic information, and/or other measurement data and other parameters of interest.

Further as shown in FIG. 1.1, each of the wellsite system A (114-1), wellsite system B (114-2), and wellsite system C (114-3) is associated with a rig, a wellbore, and other wellsite equipment configured to perform wellbore operations, such as logging, drilling, fracturing, production, or other applicable operations. For example, the wellsite system A (114-1) is associated with a rig (101), a wellbore (103), and drilling equipment to perform drilling operation. Similarly, the wellsite system B (114-2) and wellsite system C (114-3) are associated with respective rigs, wellbores, other wellsite equipments, such as production equipment and logging equipment to perform production operation and logging operation, respectively. Generally, survey operations and wellbore operations are referred to as field operations of the field (100). In addition, data acquisition tools and wellsite equipments are referred to as field operation equipments. The field operations are performed as directed by a surface unit (112). For example, the field operation equipment may be controlled by a field operation control signal that is sent from the surface unit (112).

In one or more embodiments, the surface unit (112) is operatively coupled to the data acquisition tools (102-1), (102-2), (102-3), (102-4), and/or the wellsite systems. In particular, the surface unit (112) is configured to send commands to the data acquisition tools (102-1), (102-2), (102-3), (102-4), and/or the wellsite systems and to receive data therefrom. In one or more embodiments, surface unit (112) may be located at the wellsite system A (114-1), wellsite system B (114-2), wellsite system C (114-3), and/or remote locations. The surface unit (112) may be provided with computer facilities (e.g., an E&P computer system (118)) for receiving, storing, processing, and/or analyzing data from the data acquisition tools (102-1), (102-2), (102-3), (102-4), the wellsite system A (114-1), wellsite system B (114-2), wellsite system C (114-3), and/or other part of the field (104). The surface unit (112) may also be provided with or functionally for actuating mechanisms at the field (100). The surface unit (112) may then send command signals to the field (100) in response to data received, stored, processed, and/or analyzed, for example to control and/or optimize various field operations described above.

In one or more embodiments, the surface unit (112) is communicatively coupled to the E&P computer system (118). In one or more embodiments, the data received by the surface unit (112) may be sent to the E&P computer system (118) for further analysis. Generally, the E&P computer system (118) is configured to analyze, model, control, optimize, or perform management tasks of the aforementioned field operations based on the data provided from the surface unit (112). In one or more embodiments, the E&P computer system (118) is provided with functionality for manipulating and analyzing the data, such as performing seismic interpretation or borehole resistivity image log interpretation to identify geological surfaces in the subterranean formation (104) or performing simulation, planning, and optimization of production operations of the wellsite system A (114-1), wellsite system B (114-2), and/or wellsite system C (114-3). In one or more embodiments, the result generated by the E&P computer system (118) may be displayed for analyst user viewing using a two dimensional (2D) display, three dimensional (3D) display, or other suitable displays. Although the surface unit (112) is shown as separate from the E&P computer system (118) in FIG. 1.1, in other examples, the surface unit (112) and the E&P computer system (118) may also be combined.

Although FIG. 1.1 shows a field (100) on the land, the field (100) may be an offshore field. In such a scenario, the subterranean formation may be in the sea floor. Further, field data may be gathered from the field (100) that is an offshore field using a variety of offshore techniques for gathering field data.

FIG. 1.2 shows more details of the E&P computer system (118) in which one or more embodiments of improving continuum sedimentary basin models with particle dynamics simulations may be implemented. In one or more embodiments, one or more of the modules and elements shown in FIG. 1.2 may be omitted, repeated, and/or substituted. Accordingly, embodiments of improving continuum sedimentary basin models with particle dynamics simulations should not be considered limited to the specific arrangements of modules shown in FIG. 1.2.

As shown in FIG. 1.2, the E&P computer system (118) includes an E&P tool (230), a data repository (238) for storing intermediate data and resultant outputs of the E&P tool (230), and a field task engine (231) for performing various tasks of the field operation. In one or more embodiments, the data repository (238) may include one or more disk drive storage devices, one or more semiconductor storage devices, other suitable computer data storage devices, or combinations thereof. In one or more embodiments, content stored in the data repository (238) may be stored as a data file, a linked list, a data sequence, a database, a graphical representation, any other suitable data structure, or combinations thereof.

In one or more embodiments, the intermediate data and resultant outputs of the E&P tool (230) includes the basin snapshots (e.g., basin snapshot A (232), intermediate basin snapshot (233), and basin snapshot B (234)), the particle dynamics equation (235), the basin model (236), and the simulated evolution (237). Each basin snapshot includes a basin rock geometry estimate for a particular geologic time. In particular, the basin rock geometry estimate estimates a basin rock geometry for the rock formations in the geologic basin of the subterranean formation (104). As used herein, the term “basin rock geometry” refers to shape, size, relative positions, and other spatial properties of basin rocks. For example, the basin snapshot A (232), the intermediate basin snapshot (233), and the basin snapshot B (234) correspond to a first geologic time, an intermediate geologic time, and a second geologic time, respectively, where the intermediate geologic time is after the first geologic time and before the second geologic time. In other words, the second geologic time is younger than the first geologic time, and the intermediate geologic time is in-between the older and younger geologic times.

In one or more embodiments, the particle dynamics equation (235) represents a physical relationship between a rock particle movement and a rock particle interaction force within the geologic basin. Rock interaction forces may be due to the finite size of the rock particles and some general rock particle properties, such as stiffness of particles, surface roughness and attractive forces due to welding at contact surfaces. In particular, the particle dynamics equation (235) is used in a particle dynamic simulation of the geologic basin.

In one or more embodiments, the basin model (236) describes spatial variations of one or more attributes of the geologic basin. For example, the attributes include a rock attribute (e.g., grain sizes, mineral types, porosity, compressibility, permeability or thermal conductivity, etc.) of the rock formations in the geologic basin. The attributes may also include a geologic basin thermal history, which describes temperature records of the rock formations at different geological times. Further, the attributes may also include fluids attributes and may be referred to as a petroleum system model (PSM). For example, the fluid attributes may include composition, gas-oil ratio, distribution of hydrocarbon fractions, fluid density, fluid viscosity, saturation pressure, and identification of certain biomarkers, etc. of the fluids in the geologic basin. In addition, the attributes may also include a geologic basin charging history, which describes the geological time when the fluids enters the rock formations. Over geological time, fluid mixing in a particular reservoir, or the degree of fluid compositional variation within the reservoir, is an indicator of the charging history of a hydrocarbon accumulation and the complexity of the hydrocarbon migration paths.

In one or more embodiments, the simulated evolution (237) is a simulated result within the geologic basin that describes an estimated basin rock geometry over geologic time and an estimated fluids distribution of the fluids over geologic time. In one or more embodiments, the estimated basin rock geometry over geologic time includes an estimated pathway of rock particle movement through geological time.

In one or more embodiments, E&P computer system (118) includes the structural restoration module (222) that is configured to generate the basin snapshot A (232) and the basin snapshot B (234) by performing structural restoration of the geologic basin. Structural restoration may determine the basin geometry for different geological times based on unfolding of layers along fault throws in a backstripping and decompaction procedure by taking into account rock material balances, tectonical forces and general geological (e.g., stratigraphical) information. Basin snapshots generated by the structural restoration module (222) are also referred to as restoration snapshots.

In one or more embodiments, E&P computer system (118) includes the input module (221) that is configured to obtain the basin snapshot A (232) and the basin snapshot B (234) for use by the basin simulator (224). In one or more embodiments, the input module (221) obtains the basin snapshot A (232) and the basin snapshot B (234) from the structural restoration module (222).

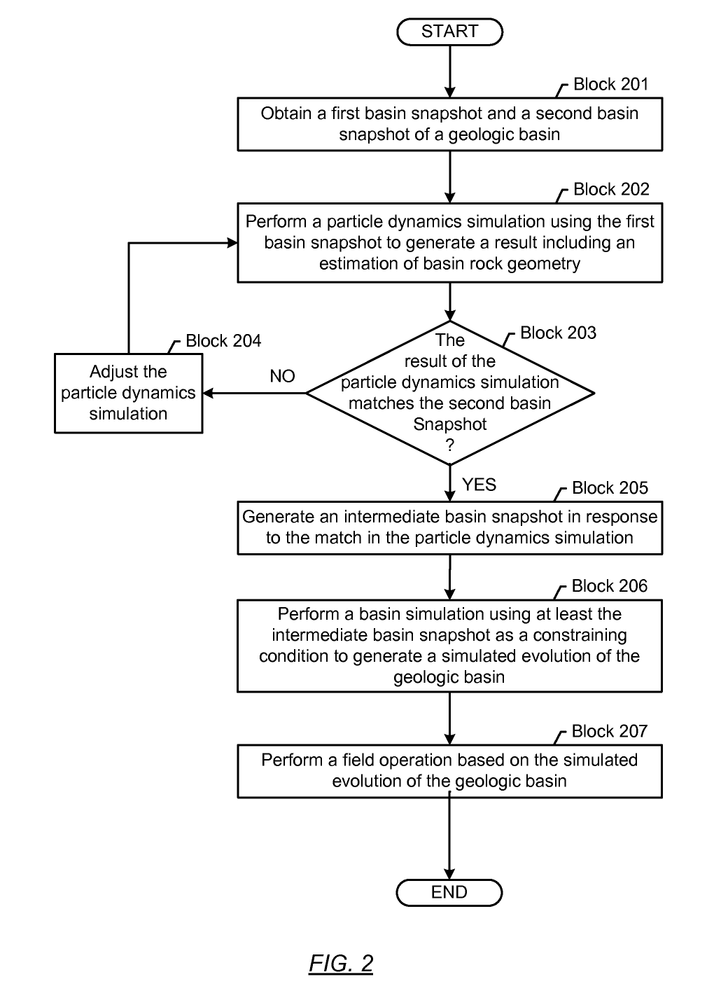

In one or more embodiments, E&P computer system (118) includes the particle dynamics simulator (223), which is a simulator that estimates the overall geometry of a geologic basin by modeling movements of small rock particles constrained by moving boundaries. Particle dynamics simulation is a technique for computing movements of particles by applying Newton's first equation of motion and using inter-particle properties (e.g., friction, various bond properties such as shear and tensile strengths, particle mass and shape, etc.) as input. In one or more embodiments, the particle dynamics simulator (223) models the movements of small rock particles based on the particle dynamics equation (235) and using at least the basin snapshot A (232) and the basin snapshot B (234) to generate the intermediate basin snapshot (233). In one or more embodiments, the particle dynamics simulator (223) uses the method described in reference to FIG. 2 below to match a result of the particle dynamics simulation to the basin snapshot B (234). As will be described in reference to FIG. 2 below, the particle dynamics simulator (223) matches the result by adjusting the particle dynamics equation (235) (e.g., parameters/coefficients contained therein) that is used for the particle dynamics simulation.

In one or more embodiments, E&P computer system (118) includes the basin simulator (224) that is configured to perform a basin simulation of the geologic basin to generate the simulated evolution (237). In particular, the intermediate basin snapshot (233) is used by the basin simulator (224) as a constraining condition for the basin simulation. Similarly, the basin snapshot A (232) and snapshot B (234) may also be used as additional constraining conditions.

In one or more embodiments, E&P computer system (118) includes the field task engine (231) that is configured to generate a field operation control signal based at least on a result generated by the E&P tool (230). As noted above, the field operation equipment depicted in FIG. 1 above may be controlled by the field operation control signal. For example, the field operation control signal may be used to control drilling equipment, an actuator, a fluid valve, or other electrical and/or mechanical devices disposed about the field (100) depicted in FIG. 1.1 above.

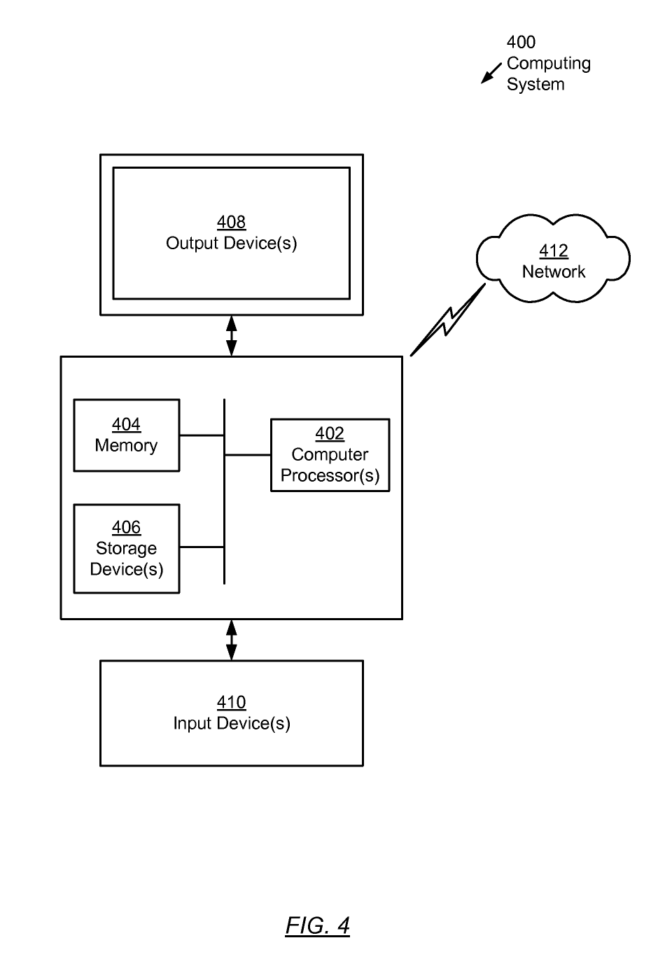

The E&P computer system (118) may include one or more system computers, such as shown in FIG. 4 below, which may be implemented as a server or any conventional computing system. However, those skilled in the art, having benefit of this disclosure, will appreciate that implementations of various technologies described herein may be practiced in other computer system configurations, including hypertext transfer protocol (HTTP) servers, hand-held devices, multiprocessor systems, microprocessor-based or programmable consumer electronics, network personal computers, minicomputers, mainframe computers, and the like.

While specific components are depicted and/or described for use in the units and/or modules of the E&P computer system (118) and the E&P tool (230), a variety of components with various functions may be used to provide the formatting, processing, utility and coordination functions for the E&P computer system (118) and the E&P tool (230). The components may have combined functionalities and may be implemented as software, hardware, firmware, or combinations thereof.

FIG. 2 depicts an example method in accordance with one or more embodiments. For example, the method depicted in FIG. 2 may be practiced using the E&P computer system (118) described in reference to FIGS. 1.1 and 1.2 above. In one or more embodiments, one or more of the elements shown in FIG. 2 may be omitted, repeated, and/or performed in a different order. Accordingly, embodiments of the method and system for sandbox visibility should not be considered limited to the specific arrangements of elements shown in FIG. 2.

In Block 201, a first basin snapshot and a second basin snapshot of a geologic basin are obtained. The first basin snapshot includes a basin rock geometry estimate for a first geologic time, and the second basin snapshot includes the basin rock geometry estimate for a second geologic time. Specifically, the basin rock geometry estimate is an estimated geometry for basin rock of the rock formations in the geologic basin. In one or more embodiments, the first basin snapshot and the second basin snapshot are generated by performing structural restoration of the geologic basin, and are also referred to as restoration snapshots. For example, the first geologic time is an older geologic time and the second geologic time is a younger geologic time. In other words, the first geologic time is prior to the second geologic time on a geological time scale.

In Block 202, a particle dynamics simulation of the geologic basin is performed using the first basin snapshot to generate a result. The first basin snapshot is used as an initial basin rock geometry for the particle dynamics simulation. Specifically, the initial basin rock geometry is divided into rock particles to represent a schematic view of the geologic basin. During the particle dynamics simulation, the movements of the rock particles through geological time are simulated based on a particle dynamics equation used in the particle dynamic simulation. The result includes an estimation of the basin rock geometry for the second geological time that is estimated based on the particle dynamics equation. The particle dynamics equation represents a physical relationship between a rock particle movement and a rock particle interaction force. In one or more embodiments, the particle dynamics equation includes one or more coefficients and parameters. Initial values of these coefficients and parameters are determined based on one or more rock properties of the geologic basin to represent the physical relationship. Accordingly, the result is initially generated using these initial coefficient/parameter values in the particle dynamics equation. An example of the particle dynamics simulation and the particle dynamics equation used therein is described in the example shown in FIGS. 3.1-3.4 below.

In Block 203, a determination is made as to whether the result of the particle dynamics simulation matches the second basin snapshot. Specifically, the result of the particle dynamics simulation and the second basin snapshot are compared to generate a difference. For example, the difference may include a measure of mismatch, as a function of locations in the geologic basin, in shape, size, relative positions, and/or other spatial properties of basin rocks. In particular, each geologic layer is identified in the result of the particle dynamics simulation for comparing to a corresponding layer in the second basin snapshot to identify the mismatch. In one or more embodiments, the result of the particle dynamics simulation and the second basin snapshot are overlaid to identify the mismatch. Accordingly, the difference represents a mismatch between two separate basin rock geometry estimates for the second geologic time, where one estimate is generated by the structural restoration and the other estimate is generated by the particle dynamics simulation.

If the determination in Block 203 is positive, i.e., the difference does not exceed a pre-determined threshold, the method proceeds to Block 205. Otherwise if the determination is negative, i.e., the difference exceeds the pre-determined threshold, the method proceeds to Block 204.

In Block 204, the particle dynamics simulation is adjusted. In one or more embodiments, the particle dynamics equation is adjusted with respect to at least a portion of the geologic basin to reduce the difference. In one or more embodiments, the particle dynamics equation is adjusted by adjusting one or more of the coefficients/parameters in the particle dynamics equation. As noted above, initial values of these coefficients and parameters are determined based on one or more rock properties of the geologic basin to represent the physical relationship. As a result, adjusting the values of these coefficients and parameters deviates from the physical relationship between the rock particle movement and the rock particle interaction force. In one or more embodiments, an adjusted value of the coefficients/parameters is determined based on a pre-determined algorithm. For example, the Monte-Carlo method may be used to generate the adjusted value. Accordingly, the initial value is substituted by the adjusted value to adjust the particle dynamics equation. Once the particle dynamics equation is adjusted, the method returns to Block 202. Accordingly, the iteration loop of Block 202, Block 203, and Block 204 iteratively adjusts the particle dynamics equation until the difference is within the pre-determined threshold. In other words, the particle dynamics simulation result matches the restoration snapshots when the iteration loop converges.

In Block 205, an additional particle dynamics simulation of the geologic basin is performed using the first basin snapshot to generate an intermediate basin snapshot. Similar to Block 202 above, the first basin snapshot is used as an initial basin rock geometry for the additional particle dynamics simulation. However, in contrast to Block 202, the additional particle dynamics simulation is performed based on the particle dynamics equation that has been adjusted with convergence of the iteration loop above. The intermediate basin snapshot includes the basin rock geometry estimate for an intermediate geologic time. The intermediate geologic time is after the first geologic time and before the second geologic time. In one or more embodiments, the convergence of the iteration loop results in a non-linear relationship between the first basin snapshot, the intermediate basin snapshot, and the second basin snapshot. In other words, Blocks 202 through 205 collectively generate the intermediate basin snap shot based on the first basin snapshot and the second basin snapshot in an non-linearly fashion. In particular, the intermediate basin snapshot is a non-linear interpolation of the first basin snapshot and the second basin snapshot.

In Block 206, using at least the intermediate basin snapshot as a constraining condition, a basin simulation of the geologic basin is performed to generate a simulated evolution of the basin rock geometry within the geologic basin. In one or more embodiments, the first basin snapshot, the intermediate basin snapshot, and the second basin snapshots are used as constraining conditions for the basin simulation. For example, the basin simulation is divided into a first simulation stage and a second simulation stage. The first simulation stage corresponds to a geological time span from the first geological time to the intermediate geological time. During the first simulation stage, the first basin snapshot and the intermediate basin snapshot are used as constraining condition to constrain the basin simulation. In other words, the basin simulation is constrained to include both the first basin snapshot and the intermediate basin snapshot during iterations of the simulation. Thus, at least one iteration of the simulation includes the first basin snapshot and at least on iteration includes the intermediate basin snapshot. Similarly, the second simulation stage corresponds to a geological time span from the intermediate geological time to the second geological time. During the second simulation stage, the intermediate basin snapshot and the second basin snapshot are used as constraining condition to constrain the basin simulation.

In one or more embodiments, the geologic basin includes a reservoir having fluids, such as hydrocarbons. In such embodiments, performing the basin simulation further generates a simulated evolution of a fluids distribution of the fluids within the geologic basin. Specifically, the simulated evolution includes an estimation of time dependent fluids source locations and migration paths over a geological time period.

In Block 207, based on the simulated evolution of the basin rock geometry and/or the fluids distribution, the field operation is performed within the geologic basin. For example, a field development plan may be defined based on the simulated evolution of the basin rock geometry and/or the fluids distribution. The field development plan may include locations where exploration wells and/or productions wells are to be drilled. Accordingly, drilling operations and subsequent production operations may be performed to extract hydrocarbons according to the field development plan.

In summary, the method described above uses the particle dynamics simulation to interpolate restoration snapshots for generating an intermediate snapshot. Accordingly, the intermediate snapshot is used as an additional constraining condition to reduce the paleo-stepping time gap of a subsequent basin simulation to improve accuracy of the basin simulation. In one or more embodiments, multiple intermediate snapshots may be generated by the method described above to further improve the accuracy of the basin simulation. Examples of generating the intermediate snapshot for a geologic basin to improve the basin simulation are described in reference to FIGS. 3.1-3.4 below.

FIGS. 3.1, 3.2, 3.3, and 3.4 show an example in accordance of one or more embodiments. In one or more embodiments, the example shown in these figures may be practiced using the E&P computer system shown in FIGS. 1.1 and 1.2, and the method described in reference to FIG. 2 above. The following example is for example purposes and not intended to limit the scope of the claims.

FIG. 3.1 shows an example geologic basin (310) where basin modeling is performed to model the tar mat (315) in the reservoir (312) that may impede hydrocarbon production. Specifically, FIG. 3.1 shows a schematic representation of the reservoir (312) that is capped by the seal (311) and charged (over geological timescales) with asphaltene contaminated oil under additional inflow of gas represented by the upward arrows. The asphaltene flocculation from hydrocarbons may form the tar mat (315) plugging reservoir pores and thus act as flow barriers. For example, the oil layer (214) may show a substantial asphaltene gradient which is increasing to the bottom of the oil column due to gravity segregation with the tar mat (315) forming at the oil/water contact. The in-reservoir process of tar mat formation may also need up to a million years and is thus occurring on geological timescales modeled with basin modeling. Production and injection wells are planned based on the basin modeling result to take into account the location and extent of the tar mat (315), otherwise production of hydrocarbons may be hindered or even inhibited. The risk of tar mat formation may be predicted with the basin modeling.

During basin modeling, the geometrical (i.e., spatial) evolution of the basin (310) may be simulated on the basis of different snapshots of the basin rock geometry and property distribution at selected geologic times. These snapshots may have been created, as overall confining geometries, from structural restorations of the basin (310). These snapshots are generally widely spaced in geological time because these snapshots are difficult to construct and based on limited, expensive and uncertain data. However, accurate basin modeling depends on rock geometries and properties of nearby spaced intermediate time steps between these restoration snapshots and the tracking of rocks and rock properties along pathways through geologic time and space.

One or more embodiments create realistic approximations by (i) extracting intermediate geometries from particle dynamics simulations, and (ii) augmenting the restoration snapshots with the intermediate geometries as constraining conditions for the basin modeling. Additionally, particle tracing may be used for rock and rock property pathway tracking in the basin model. The quality of modeling is improved as conservation of mass and energy is taken into account with higher degree of accuracy. In other words, the method described in reference to FIG. 2 above integrates continuum geomechanical basin modeling with particle dynamics to improve the modeling accuracy.

Prior to basin modeling, structural restoration is performed to construct basin snapshots of the basin geometry at relevant geological time points. FIG. 3.2 shows examples of basin snapshots, each depicting a basin rock geometry estimate for a particular geologic time point. As noted above, the basin rock geometry estimate is an estimate of a basin rock geometry (e.g., geometrical shape of the layer (325)) for a rock formation. As shown in FIG. 3.2, snapshot 0 Ma (321), snapshot 15 Ma (322), and snapshot 99 Ma (323) are basin snapshots at geological time points of 0 Ma (i.e., megaannum, or one million years prior to present day), 15 Ma, and 99 Ma, respectively. In particular, the geometrical shape of the layer (325), bounded by an upper boundary and a lower boundary that are intersected by the fault (324), evolves among the snapshot 0 Ma (321), snapshot 15 Ma (322), and snapshot 99 Ma (323). In this example, 0 Ma is the present time, 15 Ma is a relatively young geological time point at 15 million years ago, and 99 Ma is the oldest geological time point at 99 million years ago. For example, the snapshot 15 Ma (322), and snapshot 99 Ma (323) may be constructed using a backstripping/decompaction method from the present day snapshot 0 Ma (321). The back stripping method is a modeling method which goes backward in time for reconstruction of the geometry (e.g., geometrical shape of the layer (325)), with sliding fault blocks moving along predefined fault planes (e.g., fault (324)) under consideration of geomechanical stresses that are calculated from rock overburden load. As shown in FIG. 3.2, the geometries of the snapshot 0 Ma (321), snapshot 15 Ma (322), and snapshot 99 Ma (323) are each bounded by a fixed boundary to the left and a respectively moving boundary to the right. The moving boundaries of the snapshot 0 Ma (321), snapshot 15 Ma (322), and snapshot 99 Ma (323) indicates that the geologic basin is a compressional basin where the horizontal span of the geologic basin is compressed laterally over time to reduce in size.

As described above, the snapshot 0 Ma (321), snapshot 15 Ma (322), and snapshot 99 Ma (323) may be used as constraining conditions (e.g., confining paleo-geometries) in basin modeling. The simulation time period between two consecutive constraining conditions is referred to as a paleo-step. The basin simulation switches (referred to as “paleo-stepping”), during forward simulation in time, from one paleo-geometry (i.e., rock geometry of a basin snapshot, such as the snapshot 99 Ma (323)) to the subsequent paleo-geometry (e.g., the snapshot 15 Ma (322)). The time span of the paleo-step is referred to as a time gap of the paleo-stepping. Large time gaps in paleo-stepping (e.g., exceeding several millions of years, such as 10 Ma) are very problematic for accurate basin simulations. For example, the basin simulator uses the paleo-geometry in the snapshot 99 Ma (323) during forward simulation and then, suddenly, at one specific time point of 15 Ma, switches to using the paleo-geometry in the snapshot 15 Ma (322) to continue the simulation. With increasing paleo-stepping time gaps, the paleo-geometries deviate from each other and cause the basin modeling to become excessively inaccurate as intermediate geometries are not taken into account. For example, continuous heating of a source rock following continuous subsidence while a corresponding fault block moves down during the paleo-step is not taken into account and results in the inaccuracy of the basin modeling result. Further, creating intermediate geometries by linear interpolations of restoration snapshots fails to address this type of inaccuracy.

Inaccuracies may also exist in tracking the rocks and rock properties between paleo-geometries. In other words, it is difficult to determine which piece of rock in the older paleo-geometry corresponds to which piece of rock in the younger paleo-geometry. Accuracy of the basin modeling depends on whether the temperature, pressure, etc. of each piece of rock of the younger paleo-geometry match the temperature, pressure, etc. of the corresponding piece of rock in the older paleo-geometry. Simple rule-based methods (e.g., linear mapping) have been used to map rock properties within layers of two subsequent paleo-geometries. However, layers may be split by the occurrence of a new fault resulting in inaccurate mapping. Additionally, overall mass and energy balances may not be conserved as layers extend or shrink between two subsequent paleo-geometries. In addition to rock volume conservation problems, other extensive quantities, such as the overall amount of organic content may exhibit an artifact of a large discontinuity between the subsequent paleo-geometries. As the oil generation potential derived from the organic content is a main focus of basin modeling, large paleo-stepping time gap is a problem for basin modeling.

The method described in reference to FIG. 2 above uses particle dynamics simulations to overcome the basin modeling inaccuracies resulted from large paleo-stepping time gaps. FIG. 3.3 shows an example of performing the particle dynamics simulation to generate an intermediate basin snapshot from the snapshot 0 Ma (321) and snapshot 15 Ma (322) shown in FIG. 3.1 above. Adding the intermediate basin snapshot to the constraining conditions of the basin simulation, the paleo-step is reduced from 15 Ma to two shorter paleo-steps of 5 Ma and 10 Ma each. Specifically, FIG. 3.3. shows the basin geometry 5 Ma (338) in the intermediate basin snapshot in comparison with the basin geometry 0 Ma (339) corresponding to a portion of the snapshot 0 Ma (321) and the basin geometry 15 Ma (337) corresponding to a portion of the snapshot 15 Ma (322). The basin geometry 5 Ma (338) is an estimate of rock geometry at the geological time point of 5 Ma, or 5 million years prior to present day. In particular, the fault (334), the layer (335), and the fixed/moving boundaries shown in FIG. 3.3 correspond to the fault (324), the layer (325), and the fixed/moving boundaries, respectively, shown in FIG. 3.2.

As shown in FIG. 3.3, due to lateral compression, layers (e.g., layer (335)) may have become thicker in vertical direction over geological time from 15 million years ago (15 Ma) till present day (0 Ma). The thickness changes result in difficulty to track movements of rock particles and rock properties (e.g., temperature, pressure, organic content, etc.) over geological time. As noted above, particle dynamics simulation is performed to address this difficulty in rock particle tracking. Specifically, each rock particle (e.g., particle (336)) shown in FIG. 3.3 represents one piece of rock with a corresponding set of properties. The location of each rock particle is tracked during the particle dynamics simulation. For example, the layer (335) may be tracked throughout the particle dynamics simulation from 15 Ma to 0 Ma as the set of particles identified at the beginning of the simulation at 15 Ma. By incrementally generating multiple intermediate snapshots, intermediate geometries may be created as continuously evolving layers for incrementally increasing geological time points between 15 Ma and 0 M. For example, the incrementally progressing geological time points may include 14.9 Ma, 14.8 Ma, . . . 5.1 Ma, 5 Ma, 4.9 Ma, . . . 0.2 Ma, and 0.1 Ma. Within each layer (e.g., layer (335)), the location of each rock particle and associated rock properties may be tracked through the geological time scale from 15 Ma to 0 Ma. Accordingly, extensive quantities, such as the overall amount of organic content are conserved when the number of particles is maintained constant within each layer over the geological time scale from 15 Ma to 0 Ma.

By setting up two paleo-geometries bounding one paleo-step to cover a single geological event without any new fault occurring during the paleo-step, the resulting geometry generated by the particle dynamics simulation as an estimation at the end of the paleo-step may not deviate too much from the restoration snapshot. However, newly appearing faults within the paleo-step may require adjusting initial settings and properties of the particles in the particle dynamics simulation to maintain the match. For example, the attractive and repulsive forces between the particles (i.e., particle interaction force) may be empirically adjusted in the particle dynamics equation to enforce faulting at specific locations. This procedure represents an inversion of the particle dynamics simulation. The computation time and resource requirement are affordable as the inversion is restricted to one paleo-step at a time while multiple inversions may be performed in advance of the basin simulation that includes multiple paleo-steps.

To match the resulting geometry of the particle dynamics simulation at the end of the paleo-step and the restoration snapshot, an adjustment may be selectively applied to a limited set of rock particles. FIG. 3.4 shows an example of selective adjustment in rock particle bounding forces at known fault locations. As shown in FIG. 3.4, the restoration snapshot A (341) is mapped geometrically to the particle model A (351). The circles in the particle model A (351) represent rock particles in the restoration snapshot A (341) at an older geological time point. The particle dynamics simulation is performed based on the particle dynamics equation to track particle movements (e.g., particle tracking (355)) starting from the particle model A (351). Accordingly, the particle model B (353) is generated that corresponds to a younger geological time point of the restoration snapshot B (343). The particle dynamics equation is empirically adjusted to match the particle model B (353) and the restoration snapshot B (343). Once the match is achieved, the adjusted particle dynamics equation is used to generate the particle model I (352) corresponding to an intermediate geological time point between the older geological time point of the restoration snapshot A (341) and the younger geological time point of the restoration snapshot B (343). Accordingly, the locations and rock particle properties of rock particles in the particle model I (352) are spatially mapped to generate the intermediate snapshot (342).

As noted above, the particle dynamics equation represents a physical relationship between a rock particle movement and a rock particle interaction force within the geologic basin. The rock particle interaction force between two particles may be represented as Fₘₙ and is a function of the distance r between the two particles. For example, the function may be defined to represent a repelling force as

$${F}_{mn} = \{ \begin{matrix}{k}_{mn} ( r - R ) {e}_{r} \\ 0\end{matrix} , \begin{matrix}r \leq R \\ r > R\end{matrix} ,$$

where kₘₙ is a coupling parameter, and R is a pre-determined maximum interaction distance. For example, R may correspond to the particle radius. Accordingly, total exerted force for a particle may be represented as

$${F}_{m} = {\sum }_{n \neq m} {F}_{mn} .$$

The rock particle movement for a particle at location xₘ with mass M may then be derived using the Newton's equation of motion aₘ=Fₘ/M where aₘ represents the acceleration of the particle. Based on this particle dynamics equation, the coupling parameter kₘₙ may be empirically adjusted to match the particle model B (353) and the restoration snapshot B (343).

For any two particles (denoted by m and n) separated by a fault location (344), the particle dynamics equation may be selectively adjusted (e.g., within an empirical range near the fault location (344)) until the particle dynamics simulation shows a fault in the particle model B (353) that matches a corresponding fault in the restoration snapshot B (343). For example, the particle dynamics equation may be selectively adjusted by reducing the coupling parameter kₘₙ and/or reducing the maximum interaction distance R. The empirical range and/or the amount of reduction may also be adjusted.

Embodiments may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (400) may be located at a remote location and connected to the other elements over a network (412). Further, embodiments may be implemented on a distributed system having a plurality of nodes, where each portion may be located on a different node within the distributed system. In one embodiment, the node corresponds to a distinct computing device. The node may correspond to a computer processor with associated physical memory. The node may correspond to a computer processor or micro-core of a computer processor with shared memory and/or resources.

While one or more embodiments have been described with respect to a limited number of embodiments, those skilled in the art, having benefit of this disclosure, will appreciate that other embodiments may be devised which do not depart from the scope as disclosed herein. Accordingly, the scope should be limited only by the attached claims.

What is claimed is:

1. A method for performing a field operation within a geologic basin having a plurality of rock formations, comprising:
obtaining a first basin snapshot of the geologic basin, wherein the first basin snapshot comprises a basin rock geometry estimate for a first geologic time, the basin rock geometry estimate estimating a basin rock geometry for the plurality of rock formations;
obtaining a second basin snapshot of the geologic basin, wherein the second basin snapshot comprises the basin rock geometry estimate for a second geologic time;
performing a particle dynamics simulation of the geologic basin using at least the first basin snapshot and the second basin snapshot to generate an intermediate basin snapshot, wherein the intermediate basin snapshot comprises the basin rock geometry estimate for an intermediate geologic time, wherein the intermediate geologic time is after the first geologic time and before the second geologic time;
performing, using at least the intermediate basin snapshot as a constraining condition, a basin simulation of the geologic basin to generate a simulated evolution of the basin rock geometry within the geologic basin; and
performing, based on the simulated evolution of the basin rock geometry, the field operation within the geologic basin.

2. The method of claim 1, further comprising:
generating the first basin snapshot and the second basin snapshot by performing structural restoration of the geologic basin.

3. The method of claim 1,
wherein the first basin snapshot further comprises a basin rock property distribution estimate for the first geologic time,
wherein the second basin snapshot further comprises the basin rock property distribution estimate for the second geologic time, and
wherein the intermediate basin snapshot further comprises the basin rock property distribution estimate for the intermediate geologic time.

4. The method of claim 1,
wherein the simulated evolution of the basin rock geometry comprises an estimated pathway of rock particle movement through geological time.

5. The method of claim 1,
wherein the basin simulation comprises a first simulation stage and a second simulation stage,
wherein the first simulation stage uses the first basin snapshot and the intermediate basin snapshot to constrain the basin simulation, and
wherein the second simulation stage uses the second basin snapshot and the intermediate basin snapshot to constrain the basin simulation.

6. The method of claim 1, further comprising:
comparing the basin rock geometry estimate for the second geologic time and a result of the particle dynamics simulation to generate a difference;
identifying a particle dynamics equation used in the particle dynamic simulation, wherein the particle dynamics equation represents a physical relationship between a rock particle movement and a rock particle interaction force; and
adjusting the particle dynamics equation with respect to at least a portion of the geologic basin to reduce the difference,
wherein adjusting the particle dynamics equation deviates from the physical relationship between the rock particle movement and the rock particle interaction force.

7. The method of claim 6, further comprising:
determining, based on a rock property of the geologic basin, an initial value of a coefficient in the particle dynamics equation, wherein the result of the particle dynamics simulation is generated using the initial value of the coefficient; and
empirically determining an adjusted value of the coefficient based on a pre-determined algorithm,
wherein adjusting the particle dynamics equation comprises substituting the initial value by the adjusted value.

8. The method of claim 6, further comprising:
iteratively adjusting the particle dynamics equation until the difference is within a pre-determined threshold,
wherein iteratively adjusting the particle dynamics equation results in a non-linear relationship between the first basin snapshot, the intermediate basin snapshot, and the second basin snapshot.

9. The method of claim 1, the geologic basin further having a reservoir comprising fluids,
wherein performing the basin simulation further generates the simulated evolution of a fluids distribution of the fluids within the geologic basin, and
wherein performing the field operation is further based on the simulated evolution of the fluids distribution.

10. A system for performing a field operation within a geologic basin having a plurality of rock formations, comprising:
an exploration and production (E&P) computer system, and comprising:
a computer processor;
memory storing instructions executed by the computer processor, wherein the instructions comprise:
an input module configured to:
obtain a first basin snapshot of the geologic basin, wherein the first basin snapshot comprises a basin rock geometry estimate for a first geologic time, the basin rock geometry estimate estimating a basin rock geometry for the plurality of rock formations; and
obtain a second basin snapshot of the geologic basin, wherein the second basin snapshot comprises the basin rock geometry estimate for a second geologic time;
a particle dynamics simulator configured to:
perform a particle dynamics simulation of the geologic basin using at least the first basin snapshot and the second basin snapshot to generate an intermediate basin snapshot, wherein the intermediate basin snapshot comprises the basin rock geometry estimate for an intermediate geologic time, wherein the intermediate geologic time is after the first geologic time and before the second geologic time; and
a basin simulator configured to:
perform, using at least the intermediate basin snapshot as a constraining condition, a basin simulation of the geologic basin to generate a simulated evolution of the basin rock geometry within the geologic basin; and
a repository for storing the first basin snapshot, the intermediate basin snapshot, and the second basin snapshot; and
a field equipment coupled to the E&P computer system and configured to perform, based on the simulated evolution of the basin rock geometry, the field operation within the geologic basin.

11. The system of claim 10, wherein the instructions further comprise a structural restoration module configured to:
generate the first basin snapshot and the second basin snapshot by performing structural restoration of the geologic basin.

12. The system of claim 10,
wherein the first basin snapshot further comprises a basin rock property distribution estimate for the first geologic time,
wherein the second basin snapshot further comprises the basin rock property distribution estimate for the second geologic time, and
wherein the intermediate basin snapshot further comprises the basin rock property distribution estimate for the intermediate geologic time.

13. The system of claim 10,
wherein the simulated evolution of the basin rock geometry comprises an estimated pathway of rock particle movement through geological time.

14. The system of claim 10,
wherein the basin simulation comprises a first simulation stage and a second simulation stage,
wherein the first simulation stage uses the first basin snapshot and the intermediate basin snapshot to constrain the basin simulation, and
wherein the second simulation stage uses the second basin snapshot and the intermediate basin snapshot to constrain the basin simulation.

15. The system of claim 10, wherein the particle dynamics simulator is further configured to:
compare the basin rock geometry estimate for the second geologic time and a result of the particle dynamics simulation to generate a difference;
identify a particle dynamics equation used in the particle dynamic simulation, wherein the particle dynamics equation represents a physical relationship between a rock particle movement and a rock particle interaction force; and
adjust the particle dynamics equation with respect to at least a portion of the geologic basin to reduce the difference,
wherein adjusting the particle dynamics equation deviates from the physical relationship between the rock particle movement and the rock particle interaction force.

16. The system of claim 15, wherein the particle dynamics simulator is further configured to:
determine, based on a rock property of the geologic basin, an initial value of a coefficient in the particle dynamics equation, wherein the result of the particle dynamics simulation is generated using the initial value of the coefficient; and
empirically determine an adjusted value of the coefficient based on a pre-determined algorithm,
wherein adjusting the particle dynamics equation comprises substituting the initial value by the adjusted value.

17. The system of claim 15, wherein the particle dynamics simulator is further configured to:
iteratively adjust the particle dynamics equation until the difference is within a pre-determined threshold,
wherein iteratively adjusting the particle dynamics equation results in a non-linear relationship between the first basin snapshot, the intermediate basin snapshot, and the second basin snapshot.

18. The system of claim 10, the geologic basin further having a reservoir comprising fluids,
wherein performing the basin simulation further generates the simulated evolution of a fluids distribution of the fluids within the geologic basin, and
wherein performing the field operation is further based on the simulated evolution of the fluids distribution.

19. A non-transitory computer readable medium storing instructions for performing a field operation within a geologic basin having a plurality of rock formations, the instructions, when executed by a computer processor comprising functionality for:
obtaining a first basin snapshot of the geologic basin, wherein the first basin snapshot comprises a basin rock geometry estimate for a first geologic time, the basin rock geometry estimate estimating a basin rock geometry for the plurality of rock formations;
obtaining a second basin snapshot of the geologic basin, wherein the second basin snapshot comprises the basin rock geometry estimate for a second geologic time;
performing a particle dynamics simulation of the geologic basin using at least the first basin snapshot and the second basin snapshot to generate an intermediate basin snapshot, wherein the intermediate basin snapshot comprises the basin rock geometry estimate for an intermediate geologic time, wherein the intermediate geologic time is after the first geologic time and before the second geologic time;
performing, using at least the intermediate basin snapshot as a constraining condition, a basin simulation of the geologic basin to generate a simulated evolution of the basin rock geometry within the geologic basin; and
performing, based on the simulated evolution of the basin rock geometry, the field operation within the geologic basin.

20. The non-transitory computer readable medium of claim 19, the geologic basin further having a reservoir comprising fluids,
wherein performing the basin simulation further generates the simulated evolution of a fluids distribution of the fluids within the geologic basin, and
wherein performing the field operation is further based on the simulated evolution of the fluids distribution.
